(19) United States
(12) Patent Application Publication
(10) Pub. No.: US 2026/0188335 A1
(43) Pub. Date: Jul. 2, 2026

(54) VOICE QUALITY CONVERSION DEVICE, VOICE QUALITY CONVERSION METHOD, VOICE QUALITY CONVERSION NEURAL NETWORK, PROGRAM, AND RECORDING MEDIUM

(71) Applicant: DWANGO CO., LTD., Tokyo (JP)

(72) Inventors: Shinya KITAOKA, Tokyo (JP); Kazuyuki HIROSHIBA, Tokyo (JP); Kazuki FUJITA, Tokyo (JP)

(73) Assignee: DWANGO CO., LTD., Tokyo (JP)

(21) Appl. No.: 18/863,809

(22) PCT Filed: Jul. 27, 2023
(86) PCT No.: PCT/JP2023/027485

§ 371 Date: Nov. 7, 2024

(30) Foreign Application Priority Data
Jul. 29, 2022 (JP) 2022-121366

(51) Int. Cl. G10L 21/007; G10L 21/013; G10L 25/30

(52) U.S. Cl. CPC G10L 21/007; G10L 25/30; G10L 2021/0135

(57) ABSTRACT

A voice quality conversion device includes an input unit for receiving an input of source speech and speaker information, and a conversion unit for using a trained neural network to convert the quality of the source speech to obtain speech that is in accordance with conversion-destination speaker information. The neural network includes: an encoder for receiving speech and outputting a latent expression S1; a flow for converting the latent expression S1 to a speaker-independent latent expression from which a characteristic of the source speaker has been removed while preserving the features of the manner of utterance, and reverse-converting the speaker-independent latent expression to a latent expression S2 by adding a characteristic of the conversion-destination speaker; and a Vocoder for inputting the latent expression S2 and outputting conversion-destination speech.

### FIELD

The present invention relates to a voice quality conversion device, a voice quality conversion method, a program, and a recording medium.

### BACKGROUND

The quality of synthesis has been greatly improved in accordance with the recent development in a deep learning technology. NPL 1 is a technology in which speech creation from a text and voice quality conversion can be performed. NPL 2 is a technology in which the speech of a speaker other than a speaker whose speech is used for training is converted on the basis of the technology of NPL 1, and is capable of performing voice quality conversion on the speech of any speaker.

### NON PATENT LITERATURE

NPL 1: Jaehyeon Kim, Jungil Kong, and Juhee Son, “Conditional Variational Autoencoder with Adversarial Learning for End-to-End Text-to-Speech,” Proceedings of the 38th International Conference on Machine Learning, 2021, Vol. 139 of PMLR, pp. 5530-5540
NPL 2: “[OV2L Evolving Summit] Session 4 “Converting VITS to any-to-many VC” presented by kaffelun”, Internet <URL:https://youtu.be/uRwFHuXw3Qk>

### SUMMARY

In the voice quality conversion of the related art, even in a case where a source speech is input as a distinctive speech including the manner of utterance such as a whispered voice, a falsetto, and an angry voice, the source speech is converted into a calm voice (a normal speech) of a conversion-destination speech used for training. In a case where the speech such as the whispered voice, the falsetto, and the angry voice is trained as the speech of an individual speaker, the whispered voice, the falsetto, and the angry voice are designated as the conversion-destination speech, and thus, can be converted into the distinctive speech. However, in the case of conversion to the speeches of a plurality of people, it is necessary to prepare the whispered voices, the falsettos, and the angry voices of all the people as a training speech. In addition, there is a problem that conversion to an intermediate voice between the calm voice and the whispered voice is not available.

The invention has been made in consideration of the above, and an object thereof is to when a distinctive speech is input during voice quality conversion, output a speech on which the feature of the distinctive speech is reflected.

A voice quality conversion device of one aspect of the invention, includes: an input unit receiving source speech data and meta-information desired to be manipulated during voice quality conversion; and a conversion unit voice-quality-converting the source speech data to speech data according to the meta-information by using a trained neural network, in which the neural network includes an encoder receiving speech data and outputting a first latent expression by extracting a feature from the speech data, a flow converting the first latent expression to a second latent expression from which a feature corresponding to the meta-information is removed while preserving a predetermined feature included in the speech data, and performing reverse conversion to a third latent expression by adding a feature corresponding to conversion-destination meta-information to the second latent expression, and a decoder receiving the third latent expression and outputting conversion-destination speech data.

A voice quality conversion device of one aspect of the invention, includes: an input unit receiving source speech data and meta-information desired to be manipulated during voice quality conversion; and a conversion unit voice-quality-converting the source speech data to speech data according to the meta-information by using a trained neural network, in which the neural network includes a second encoder receiving speech data and outputting a second latent expression from which a feature corresponding to the meta-information is removed while preserving a predetermined feature included in the speech data, a flow performing reverse conversion to a third latent expression by adding a feature corresponding to conversion-destination meta-information to the second latent expression, and a decoder receiving the third latent expression and outputting conversion-destination speech data.

According to the invention, when the distinctive speech is input during voice quality conversion, it is possible to output the speech on which the feature of the distinctive speech is reflected.

### BRIEF DESCRIPTION OF DRAWINGS

FIG. 1 is a diagram illustrating an example of a configuration of a voice quality conversion device of this embodiment.

FIG. 2 is a diagram illustrating an example of a configuration of a neural network of a first embodiment.

FIG. 3 is a flowchart illustrating an example of a processing flow during voice quality conversion of the first embodiment.

FIG. 4 is a diagram illustrating an example of a configuration of a neural network of second embodiment.

FIG. 5 is a flowchart illustrating an example of a processing flow during voice quality conversion of the second embodiment.

FIG. 6 is a diagram illustrating an example of a training method of the neural network of the second embodiment.

### DETAILED DESCRIPTION

### First Embodiment

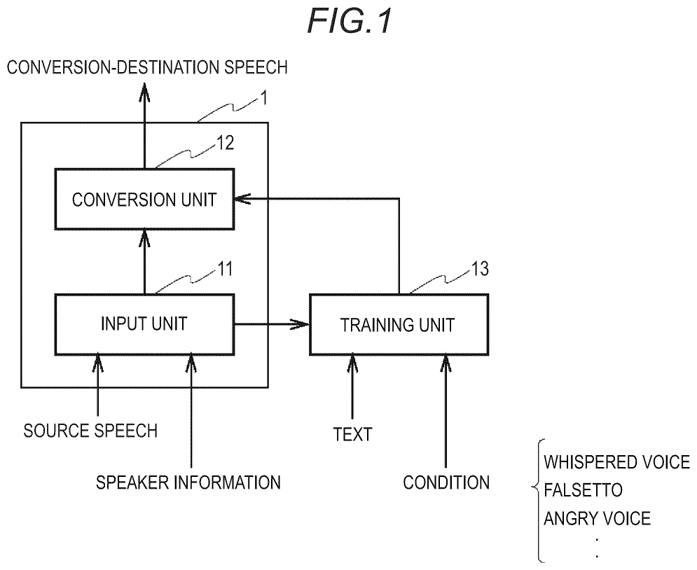

With reference to FIG. 1, an example of the configuration of a voice quality conversion device 1 of a first embodiment will be described. The voice quality conversion device 1 illustrated in the same drawing includes an input unit 11, a conversion unit 12, and a training unit 13. Each unit of the voice quality conversion device 1 is configured by at least one or more computers including an arithmetic processing device, a storage device, and the like, and the processing of each unit may be executed by a program. Such a program is stored in a storage device of the voice quality conversion device 1, and can also be recorded in a recording medium such as a magnetic disk, an optical disk, and a semiconductor memory, or provided through a network.

The input unit 11 receives speech data (hereinafter, referred to as a speech) and speaker information. Specifically, during training, the input unit 11 receives a training speech of a speaker desired to be mutually convertible, and speaker information of the speech. The voice quality conversion device 1 of the first embodiment trains the speech of the speaker desired to be mutually convertible, and is capable of voice-quality-converting the trained speaker in a multipoint-to-multipoint manner. The speaker information is an identifier for the speaker. The speaker information is allocated to each speaker of the training speech. During training, the training speech and the speaker information of the training speech received by the input unit 11 are transmitted to the training unit 13. On the other hand, during inference (during voice quality conversion), the input unit 11 receives a source speech, source speaker information, and conversion-destination speaker information. During inference, the source speech and the speaker information received by the input unit 11 are transmitted to the conversion unit 12.

The conversion unit 12 inputs the source speech, the source speaker information, and the conversion-destination speaker information to a trained neural network, and reflects the manner of the utterance of the source speech to voice-quality-convert the source speech to a speech corresponding to the conversion-destination speaker information. The manner of the utterance is a whispered voice, a falsetto, an angry voice, and the like. For example, in a case where the source speech is the whispered voice, a conversion-destination speech is also created as a whispered voice. Both of a source speaker and a conversion-destination speaker are the speaker of the speech used for training.

The neural network of this embodiment includes an encoder outputting a latent expression of the source speech by extracting a feature from the source speech, a flow converting the latent expression of the source speech to a speaker-independent latent expression from which a speaker property (the feature of the speaker) is removed while preserving the manner of the utterance, and performing reverse conversion to a latent expression of the conversion-destination speech by adding the speaker property of the conversion-destination speaker to the speaker-independent latent expression, and a decoder (a vocoder) receiving the latent expression of the conversion-destination speech and outputting the conversion-destination speech. The details of the model will be described below.

The training unit 13 inputs the training speech, the speaker information of the training speech, the text of the training speech, and the manner information of the utterance of the training speech (hereinafter, referred to as a condition), and limits a distribution that an intermediate expression of a variational auto-encoder including an encoder and a vocoder follows to a distribution created by the text and the condition to train the neural network. In other words, the training unit 13 trains the neural network such that the vocoder is capable of restoring the latent expression output from the encoder to the original speech, and the latent expression from which the speaker property is removed while preserving the feature of the manner of the utterance is closer to an expression created from a text not including the feature of the speaker and the manner information of the utterance. The text is phonological information of the training speech. The condition, for example, is a flag of 0 and 1 indicating the manner of the utterance of the training speech such as a whispered voice, a falsetto, and an angry voice. In a case where the training speech is the whispered voice, as the condition, information indicating the whispered voice is input to the training unit 13. A parameter (the neural network) trained by the training unit 13 is stored in the storage device of the voice quality conversion device 1.

### (Model and Training)

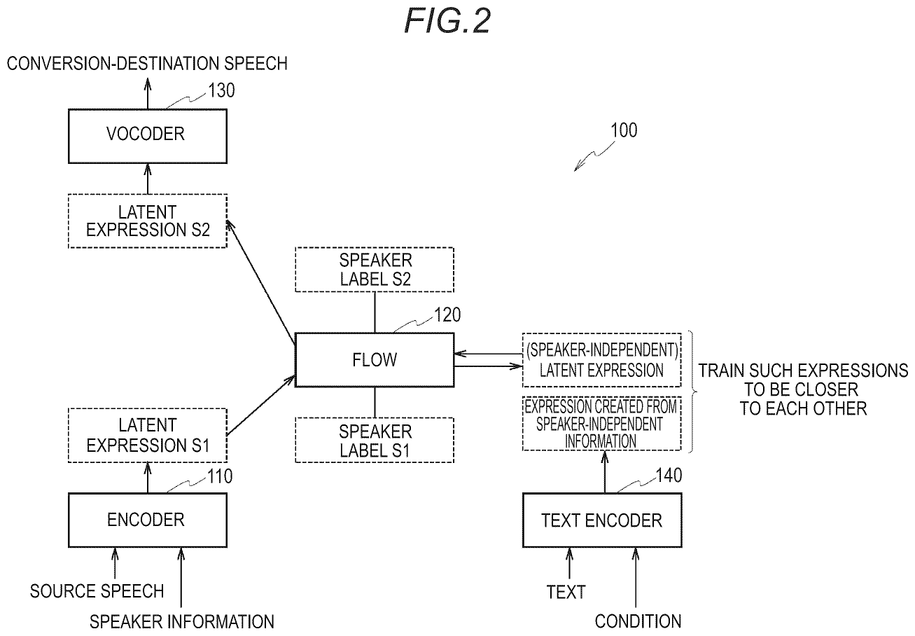

With reference to FIG. 2, an example of the neural network and an example of the training of the first embodiment will be described. A neural network 100 illustrated in the same drawing includes an encoder 110, a flow 120, a vocoder 130, and a text encoder 140.

A structure including the encoder 110 and the vocoder 130 corresponds to a variational auto-encoder. In a case where a speech is input to the encoder 110, a latent expression is obtained. In a case where a latent expression is input to the vocoder 130, a speech is output. The latent expression has information relevant to a sound.

In a case where a latent expression and speaker information are input, the flow 120 outputs a speaker-independent latent expression in which a speaker property is maximally removed from the latent expression. In addition, the flow 120 is an invertible neural network. In a case where a speaker-independent latent expression is input to the flow 120 in reverse direction, and conversion-destination speaker information is added, a latent expression of a conversion-destination speaker is obtained. By inputting the latent expression output from the flow 120 to the vocoder 130, it is possible to output the speech of the conversion-destination speaker.

The text encoder 140 is a neural network used during training, and is not required during inference. The text encoder 140 receives the text and the condition of a training speech, and outputs a latent expression in which the condition is provided to the text. The latent expression output from the text encoder 140 is an expression created from speaker-independent text and condition, and does not include a speaker property.

During training, the training speech and the speaker information of the training speech are input to the encoder 110, and the text and the condition of the training speech are input to the text encoder 140. The neural network is trained such that the speech input to the encoder 110 and the speech output from the vocoder 130 are the same, and simultaneously, the neural network 100 is trained such that the latent expression output from the flow 120 and an expression created from the speaker-independent information output from the text encoder 140 are closer to each other. The latent expression output from the encoder 110 is converted and reverse-converted with the flow 120, and then, input to the vocoder 130. During conversion in the flow 120, the speaker property is removed, and during reverse conversion, the speaker property is provided. The speaker property provided during training and reverse conversion is the speaker property of the training speech. Training is performed such that a spectrogram of the speech input to the encoder 110 and a spectrogram of the speech output from the vocoder 130 are coincident with each other. In training for making the latent expression output from the flow 120 and the expression output from the text encoder 140 closer to each other, monotonic alignment search can be used as with NPL 1. In the latent expression output from the flow 120, a horizontal axis is time, and in the expression created from the speaker-independent information output from the text encoder 140, a horizontal axis is a phoneme. The correspondences thereof are obtained by monotonic alignment, and a limitation is put such that the correspondences are closer to each other. In this embodiment, the condition is input to the text encoder 140, as second information in addition to the phoneme. Accordingly, the neural network 100 is trained such that the flow 120 outputs a latent expression in which the speaker property is removed and the feature of the manner of the utterance is included.

As the training speech, the speech of a person whose voice is desired to be voice-quality-converted is prepared in a multipoint-to-multipoint manner. For example, in a case where the speeches of three people of a person A, a person B, and a person C are trained as the training speech, after training, the speech of the person A can be voice-quality-converted to the speech of the person B or the person C, the speech of the person B can be voice-quality-converted to the speech of the person A or the person C, and the speech of the person C can be voice-quality-converted to the speech of the person A or the person B.

During training, it is not necessary that there are all training speeches of the corresponding conditions. Specifically, in a case where the voice quality conversion device 1 handles a whispered voice, there may be no training speech of the whispered voice of the person C insofar as there is the training speech of the whispered voice of the person A or the person B. That is, it is not necessary to prepare the training speeches for all speakers to be trained and all variations of the condition that the voice quality conversion device 1 handles.

In a case where the training speech is a speech including the manner of the utterance, the manner information of the utterance is also input to the text encoder 140 together with the text. For example, in a case where the speech of the whispered voice of the person A is trained as the training speech, the training speech of the person A and speaker information indicating the person A are input to the encoder 110, and the text of the training speech and a flag indicating the whispered voice are input to the text encoder 140.

The speaker information input to the neural network 100 can also be referred to as meta-information desired to be manipulated during voice quality conversion. As described above, in a case where the speaker property is desired to be controlled, the speaker information is input as the meta-information. In a case where a pitch or an intonation is used as the speaker information, the voice quality conversion can be performed by controlling the pitch or the intonation. By designating the pitch or the intonation, it is possible to output a speech in which the high voice, the low voice, and the intonation of the conversion-destination speaker are controlled. On the other hand, the text and the condition input to the text encoder 140 are information that is not changed during conversion. In other words, the text and the condition are a feature included in a speech desired to be preserved even after conversion.

In a case where the intonation is input as the condition input to the text encoder 140 together with the text, that is, in a case where the intonation is handled as the information that is not changed during voice quality conversion, each phoneme obtained from the text has a temporal length, but the condition does not have a temporal length. Therefore, it may be devised to match the temporal length of the phonological information and the temporal length of the condition in the monotonic alignment. For example, the information of the intonation is extracted from the training speech, and the temporal length of the intonation is matched to the temporal length of the speech information.

Note that in order to consider a difference in the training speech according to a microphone or an environment such as a space, a training speech to which a noise is added may be input to the encoder 110, and training may be performed such that a clean speech is output from the vocoder 130.

### (Voice Quality Conversion Processing)

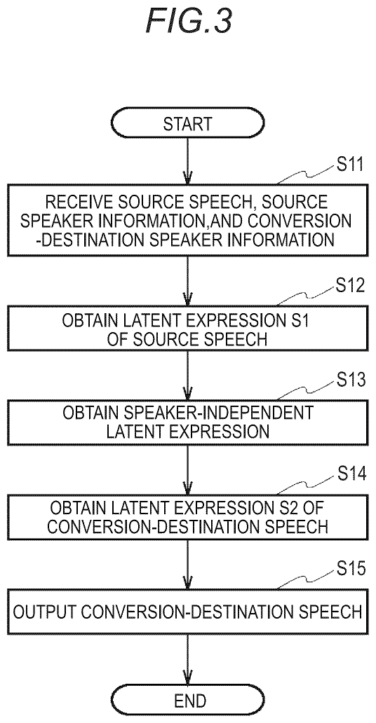

With reference to FIG. 3, a processing flow during voice quality conversion will be described.

In step S11, the input unit 11 receives the source speech, the source speaker information, and the conversion-destination speaker information, and transmits the source speech, the source speaker information, and the conversion-destination speaker information to the conversion unit 12. The voice quality conversion device 1 processes the speech in a predetermined sampling number (slice) unit. In a case where the source speech is input in real-time, the source speech can be processed in a slice unit in real-time, and voice-quality-converted in real-time. Both of the source speaker and the conversion-destination speaker are any one of the speakers of the training speeches.

In step S12, the conversion unit 12 inputs the source speech and the source speaker information to the encoder 110 to obtain a latent expression S1 from the encoder 110. The latent expression S1 is a latent expression including the speaker property of the source speech.

In step S13, the conversion unit 12 inputs the latent expression S1 and the source speaker information to the flow 120 to obtain a speaker-independent latent expression. The speaker-independent latent expression includes the feature of the manner of the utterance of the source speech.

In step S14, the conversion unit 12 provides the conversion-destination speaker information, and reverse converts the speaker-independent latent expression with the flow 120 to obtain a latent expression S2 of the conversion-destination speech.

In step S15, the conversion unit 12 inputs the latent expression S2 and the conversion-destination speaker information to the vocoder 130 to output a conversion-destination speech on which the manner of the utterance of the source speech is reflected.

As described above, the voice quality conversion device 1 of this embodiment includes the input unit 11 receiving the source speech, the source speaker information, and the conversion-destination speaker information, and the conversion unit 12 voice-quality-converting the source speech to the speech according to the conversion-destination speaker information by using the trained neural network 100. The neural network 100 includes the encoder 110 receiving the speech and outputting the latent expression S1 by extracting the feature from the speech, the flow 120 converting the latent expression S1 to the speaker-independent latent expression from which the characteristic of the source speaker is removed while preserving the feature of the manner of the utterance included in the speech, and reverse-converting the speaker-independent latent expression to the latent expression S2 by adding the characteristic of the conversion-destination speaker, and the vocoder 130 receiving the latent expression S2 and outputting the conversion-destination speech. Accordingly, the voice quality conversion device 1 is capable of performing conversion to the voice quality of the conversion-destination speaker on which the manner of the utterance of the input speech, such as a whispered voice, a falsetto, and an angry voice, is reflected. The voice quality conversion device 1 does not designate the manner of the utterance of the speech after conversion, but the encoder 110 and the flow 120 output the latent expression including the manner of the utterance of the source speech, and thus, for example, in a case where the source speech is an intermediate speech between a calm voice and a whispered voice, a speech on which the manner of the intermediate utterance is reflected is output.

The voice quality conversion device 1 of this embodiment includes the training unit 13 inputting the training speech to the encoder 110, inputting the text of the training speech and the condition indicating the manner of the utterance included in the training speech data to the text encoder 140, and training the neural network 100 such that the vocoder 130 is capable of restoring the latent expression output from the encoder 110 to the original training speech, and the speaker-independent latent expression obtained by the conversion with the flow 120 and the expression created from the speaker-independent information output from the text encoder 140 are closer to each other. Accordingly, by the conversion of the flow 120, the latent expression is obtained in which the speaker property is removed and the manner of the utterance is included. By providing the speaker property of the conversion-destination speaker to the latent expression to perform reverse conversion, the latent expression including the speaker property of the conversion-destination speaker and the manner of the utterance is obtained.

### Second Embodiment

A voice quality conversion device of a second embodiment additionally trains the neural network 100 of the first embodiment, and voice-quality-convert the speech of any speaker. The first embodiment is the voice quality conversion device performing voice quality conversion in a multipoint-to-multipoint manner. In the second embodiment, the neural network of the first embodiment is created, and then, training is performed with a task of obtaining the speaker-independent latent expression without the speaker information of ground truth. The configuration of the voice quality conversion device of the second embodiment is the same as that of the first embodiment, and thus, the description thereof will be omitted.

### (Model and Training)

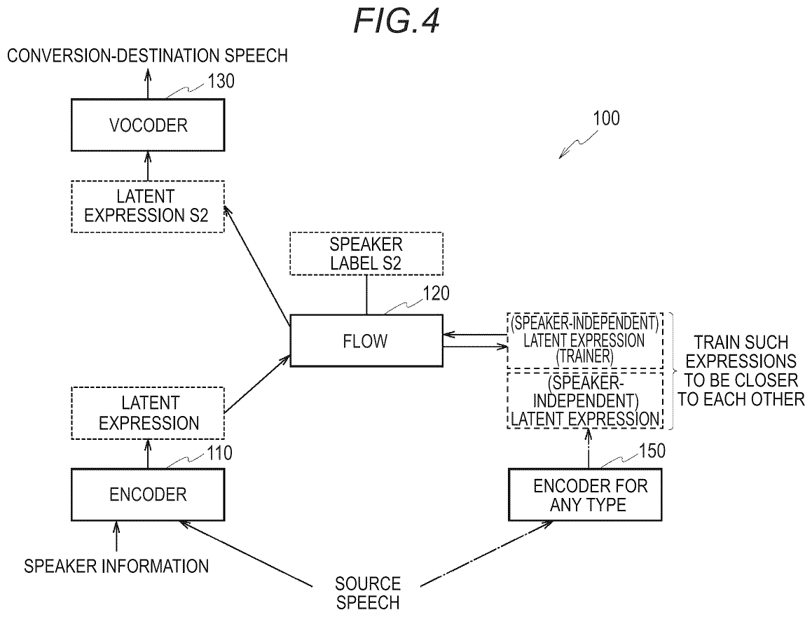

With reference to FIG. 4, an example of the neural network and an example of the training method of the second embodiment will be described. The neural network 100 illustrated in the same drawing includes the encoder 110, the flow 120, the vocoder 130, and an encoder 150 for any type. As the encoder 110, the flow 120, and the vocoder 130, the encoder, the flow, and the vocoder trained in the first embodiment are used. The text encoder 140 is not required in the training of the second embodiment.

The encoder 150 for any type is a neural network receiving a speech without speaker information and outputting a speaker-independent latent expression. In the second embodiment, the neural network is trained such that the output of the encoder 150 for any type receiving a training speech without speaker information of a source training speech is closer to the speaker-independent latent expression.

During training, the training speech and the speaker information of the training speech are input to the encoder 110, and the training speech is input to the encoder 150 for any type. The training speech used in the first embodiment is also used in the second embodiment. The training speech is input to the encoder 110 and the encoder 150 for any type, and the neural network is trained such that a latent expression obtained by converting the output of the encoder 110 with the flow 120 and the output of the encoder 150 for any type are closer to each other. The latent expression converted with the flow 120 is a latent expression in which a speaker property is removed from the training speech and the feature of the manner of the utterance is included. The encoder 150 for any type is trained to output the latent expression in which the speaker property is removed from the input speech and the feature of the manner of the utterance is included. It is considered that generality is obtained when performing training with the training speeches of a plurality of speakers of several dozen to approximately 100, and even in a case where the speech of any speaker other than the speaker of the training speech is input to the encoder 150 for any type, the latent expression in which the speaker property is removed and the feature of the manner of the utterance is included is obtained.

By reverse-converting the latent expression output from the encoder 150 for any type with the flow 120, and providing the conversion-destination speaker information, it is possible to voice-quality-convert the speech input to the encoder 150 for any type to the speech of the conversion-Substitute destination speaker.

### (Voice Quality Conversion Processing)

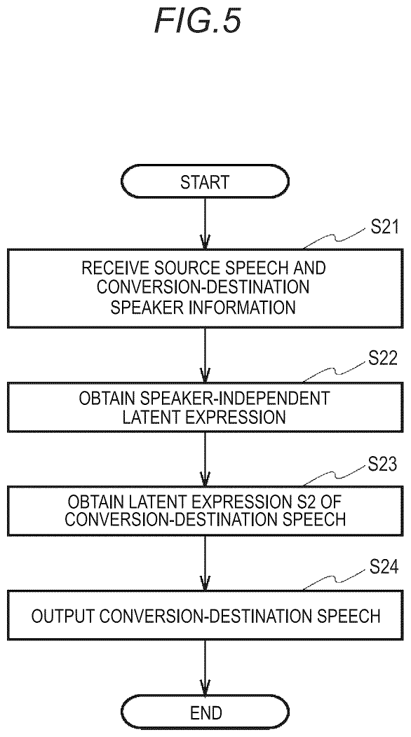

With reference to FIG. 5, a processing flow during voice quality conversion of the second embodiment will be described.

In step S21, the input unit 11 receives the source speech and the conversion-destination speaker information, and transmits the source speech and the conversion-destination speaker information to the conversion unit 12. The speaker of the source speech may not be the speaker of the training speech. That is, the speech of any speaker may be input.

In step S22, the conversion unit 12 inputs the source speech to the encoder 150 for any type to obtain the speaker-independent latent expression from the encoder 150 for any type. The speaker-independent latent expression includes the feature of the manner of the utterance of the source speech.

In step S23, the conversion unit 12 provides the conversion-destination speaker information, and reverse-converts the speaker-independent latent expression with the flow 120 to obtain the latent expression S2 of the conversion-destination speech.

In step S24, the conversion unit 12 inputs the latent expression S2 and the conversion-destination speaker information to the vocoder 130 to output the conversion-destination speech on which the manner of the utterance of the source speech is reflected.

### (Another Training Example)

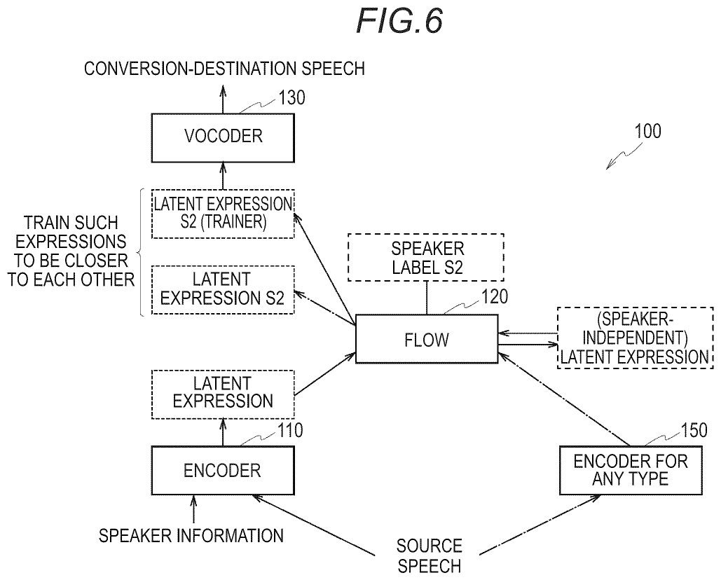

With reference to FIG. 6, an example of another training method of the neural network of the second embodiment will be described. The configuration of the neural network in FIG. 6 is the same as the configuration of the neural network in FIG. 4.

In the training example of FIG. 6, the neural network is trained such that the latent expression obtained by converting and reverse-converting the output of the encoder 110 with the flow 120 and the latent expression obtained by reverse-converting the output of the encoder 150 for any type with the flow 120 are closer to each other. The training speech is input to the encoder 150 for any type. During reverse-converting in the flow 120, the conversion-destination speaker information is provided. As described above, training may be performed to make the latent expression of the speech of the conversion-destination speaker obtained by the reverse conversion in the flow 120 closer.

Further, the latent expression obtained by the reverse conversion in the flow 120 may be input to the vocoder 130, and the neural network may be trained such that waveforms or spectrograms are closer to each other.

In addition, in the training example of FIG. 6, the training speech and the conversion-destination speaker information S2 may be input to the encoder 150 for any type, and training may be performed such that the encoder 150 for any type outputs the latent expression S2 without using the flow 120. In this case, it is possible to increase the degree of freedom of a network configuration, such as the presence or absence of the flow 120.

The training method illustrated in FIG. 4 and the training method illustrated in FIG. 6 may be combined.

As described above, the voice quality conversion device 1 of this embodiment includes the input unit 11 receiving the source speech and the conversion-destination speaker information, and the conversion unit 12 voice-quality-converting the source speech to the speech according to the conversion-destination speaker information by using the trained neural network 100. The neural network 100 includes the encoder 150 for any type receiving the speech and outputting the speaker-independent latent expression from which the characteristic of the source speaker is removed while preserving the feature of the manner of the utterance included in the speech, the flow 120 reverse-converting the speaker-independent latent expression to the latent expression S2 by adding the characteristic of the conversion-destination speaker, and the vocoder 130 receiving the latent expression S2 and outputting the conversion-destination speech. Accordingly, the voice quality conversion device 1 is capable of performing conversion to the voice quality of the conversion destination speaker on which the manner of the utterance of the speech input from any voice is reflected.

The voice quality conversion device 1 of this embodiment includes the training unit training the neural network 100 of the first embodiment, and then, inputting the training speech data to the encoder 110 and the encoder 150 for any type, and training the neural network 100 such that the speaker-independent latent expression (a trainer) obtained by the conversion with the flow 120 and the latent expression output from the encoder 150 for any type are closer to each other. Accordingly, in a case where the speech of the any speaker is input, the encoder 150 for any type is capable of outputting the latent expression in which the speaker property is removed and the manner of the utterance is included. By providing the speaker property of the conversion-destination speaker to the latent expression to perform reverse conversion, the latent expression including the speaker property of the conversion-destination speaker and the manner of the utterance is obtained.

The voice quality conversion device 1 may train the neural network 100 such that the latent expression S2 (the trainer) obtained by the reverse conversion after the conversion in the flow 120 and the latent expression S2 obtained by reverse-converting the speaker-independent latent expression output from the encoder 150 for any type flow 120 are closer to each other.

### REFERENCE SIGNS LIST

1: voice quality conversion device
11: input unit
12: conversion unit
13: training unit
100: neural network
110: encoder
120: flow
130: vocoder
140: text encoder
150: encoder for any type

1-15. (canceled)

16. A voice quality conversion device, comprising:
an input unit receiving source speech data and meta-information desired to be manipulated during voice quality conversion; and
a conversion unit voice-quality-converting the source speech data to speech data according to the meta-information by using a trained neural network,
wherein the neural network includes an encoder receiving speech data and outputting a first latent expression by extracting a feature from the speech data, a flow converting the first latent expression to a second latent expression from which a feature corresponding to the meta-information is removed while preserving a predetermined feature included in the speech data, and performing reverse conversion to a third latent expression by adding a feature corresponding to conversion-destination meta-information to the second latent expression, and a decoder receiving the third latent expression and outputting conversion-destination speech data.

17. The voice quality conversion device according to claim 16, further comprising
a training unit inputting training speech data to the encoder, inputting phonological information of the training speech data and a condition indicating a predetermined feature included in the training speech data to a text encoder, and training the neural network such that the decoder is capable of restoring the first latent expression output from the encoder to original training speech data, and the second latent expression obtained by converting the first latent expression with the flow and an expression output from the text encoder are closer to each other.

18. A voice quality conversion device, comprising:
an input unit receiving source speech data and meta-information desired to be manipulated during voice quality conversion; and
a conversion unit voice-quality-converting the source speech data to speech data according to the meta-information by using a trained neural network,
wherein the neural network includes a second encoder receiving speech data and outputting a second latent expression from which a feature corresponding to the meta-information is removed while preserving a predetermined feature included in the speech data, a flow performing reverse conversion to a third latent expression by adding a feature corresponding to conversion-destination meta-information to the second latent expression, and a decoder receiving the third latent expression and outputting conversion-destination speech data.

19. The voice quality conversion device according to claim 18, further comprising
a training unit inputting training speech data to an encoder, inputting phonological information of the training speech data and a condition indicating a predetermined feature included in the training speech data to a text encoder, and training the neural network such that the decoder is capable of restoring a first latent expression output from the encoder to original training speech data, and a latent expression obtained by converting the first latent expression with the flow and an expression output from the text encoder are closer to each other, and then
inputting training speech data to the encoder, inputting the training speech data to the second encoder, and training the neural network such that the latent expression obtained by converting the first latent expression output from the encoder with the flow and the second latent expression output from the second encoder are closer to each other.

20. The voice quality conversion device according to claim 19, further comprising
a training unit training the neural network such that a latent expression obtained by performing reverse conversion after converting the first latent expression with the flow and the third latent expression obtained by reverse-converting the second latent expression with the flow are closer to each other.

21. The voice quality conversion device according to claim 16,
wherein the meta-information is speaker information for specifying a speaker, and the predetermined feature is a manner of utterance.

22. A voice quality conversion method for causing at least one or more computers to:
receive source speech data and meta-information desired to be manipulated during voice quality conversion; and
voice-quality-convert the source speech data to speech data according to the meta-information by using a trained neural network,
wherein the neural network includes an encoder receiving speech data and outputting a first latent expression by extracting a feature from the speech data, a flow converting the first latent expression to a second latent expression from which a feature corresponding to the meta-information is removed while preserving a predetermined feature included in the speech data, and performing reverse conversion to a third latent expression by adding a feature corresponding to conversion-destination meta-information to the second latent expression, and a decoder receiving the third latent expression and outputting conversion-destination speech data.

23. The voice quality conversion method according to claim 22, for further causing at least one or more computers to:
input training speech data to the encoder;
input phonological information of the training speech data and a condition indicating a predetermined feature included in the training speech data to a text encoder; and
train the neural network such that the decoder is capable of restoring the first latent expression output from the encoder to original training speech data, and the second latent expression obtained by converting the first latent expression with the flow and an expression output from the text encoder are closer to each other.

24. A voice quality conversion method for causing at least one or more computers to:
receive source speech data and meta-information desired to be manipulated during voice quality conversion; and
voice-quality-convert the source speech data to speech data according to the meta-information by using a trained neural network,
wherein the neural network includes a second encoder receiving speech data and outputting a second latent expression from which a feature corresponding to the meta-information is removed while preserving a predetermined feature included in the speech data, a flow performing reverse conversion to a third latent expression by adding a feature corresponding to conversion-destination meta-information to the second latent expression, and a decoder receiving the third latent expression and outputting conversion-destination speech data.

25. The voice quality conversion method according to claim 24, for further causing at least one or more computers to:
input training speech data to an encoder;
input phonological information of the training speech data and a condition indicating a predetermined feature included in the training speech data to a text encoder; and
train the neural network such that the decoder is capable of restoring a first latent expression output from the encoder to original training speech data, and a latent expression obtained by converting the first latent expression with the flow and an expression output from the text encoder are closer to each other; and then
input training speech data to the encoder;
input the training speech data to the second encoder; and
train the neural network such that the latent expression obtained by converting the first latent expression output from the encoder with the flow and the second latent expression output from the second encoder are closer to each other.

26. The voice quality conversion method according to claim 25, for further causing at least one or more computers to
train the neural network such that a latent expression obtained by performing reverse conversion after converting the first latent expression with the flow and the third latent expression obtained by reverse-converting the second latent expression with the flow are closer to each other.

27. A recording medium recording a program for operating a computer as each unit of the voice quality conversion device according to claim 16.

28. The voice quality conversion device according to claim 18,
wherein the meta-information is speaker information for specifying a speaker, and the predetermined feature is a manner of utterance.

29. A recording medium recording a program for operating a computer as each unit of the voice quality conversion device according to claim 18.
